(19) United States
(12) Patent Application Publication
(10) Pub. No.: US 2026/0221323 A1
(43) Pub. Date: Jul. 30, 2026

(54) NON-ORIENTED ELECTRICAL STEEL WITH EXCELLENT COMPREHENSIVE PERFORMANCE AND MANUFACTURING METHOD THEREFOR

(71) Applicant: Baoshan Iron & Steel Co., Ltd., Shanghai (CN)

(72) Inventors: Xianshi Fang, Shanghai (CN); Quanli Jiang, Shanghai (CN); Feng Zhang, Shanghai (CN); Bo Wang, Shanghai (CN); Yunwei Hao, Shanghai (CN)

(21) Appl. No.: 19/143,728

(22) PCT Filed: Jan. 8, 2024
(86) PCT No.: PCT/CN2024/071107

§ 371 Date: Jun. 26, 2025

(30) Foreign Application Priority Data
Jan. 10, 2023 (CN) 202310033304.7

(51) Int. Cl. H01F 1/147; C21D 1/28; C21D 6/00; C21D 8/1216; C21D 8/1244; C21D 8/1277; C21D 9/46; C22C 38/00; C22C 38/02; C22C 38/04; C22C 38/06; C22C 38/08; C22C 38/10; C22C 38/12; C22C 38/14; C22C 38/20; C22C 38/24; C22C 38/26; C22C 38/28; C22C 38/30; C22C 38/32; C22C 38/34; C22C 38/42; C22C 38/46; C22C 38/48; C22C 38/50; C22C 38/52; C22C 38/54; C22C 38/58; C22C 38/60

(52) U.S. Cl. CPC H01F 1/14766; C21D 1/28; C21D 6/001; C21D 6/002; C21D 6/004; C21D 6/005; C21D 6/007; C21D 6/008; C21D 8/1222; C21D 8/1233; C21D 8/1261; C21D 8/1266; C21D 8/1283; C21D 9/46; C22C 38/001; C22C 38/002; C22C 38/004; C22C 38/008; C22C 38/02; C22C 38/04; C22C 38/06; C22C 38/08; C22C 38/105; C22C 38/12; C22C 38/14; C22C 38/20; C22C 38/24; C22C 38/26; C22C 38/28; C22C 38/30; C22C 38/32; C22C 38/34; C22C 38/42; C22C 38/46; C22C 38/48; C22C 38/50; C22C 38/52; C22C 38/54; C22C 38/58; C22C 38/60; C22C 2202/02

(57) ABSTRACT

The present disclosure provides a non-oriented electrical steel with excellent comprehensive performance comprising, in addition to Fe and inevitable impurities, the following chemical elements in percentage by mass: C≤0.0050%, Si: 3.10-4.50%, Al: 0.10%-2.00%, Mn: 0.10%-2.50%, and 3.75%≤Si+Al≤5.22%. Correspondingly, the present disclosure also discloses a method for manufacturing the non-oriented electrical steel. The non-oriented electrical steel has small magnetic anisotropy, high magnetic induction intensity, low iron loss at medium and high frequency, high yield strength, and can be widely used in iron core materials of electric vehicle drive motors, high-speed motors, and unmanned aerial vehicles, etc.

### TECHNICAL FIELD

The present disclosure relates to a steel sheet and a manufacturing method therefor, in particular to a non-oriented electrical steel sheet and a manufacturing method therefor.

### BACKGROUND

With the rapid development of electric vehicles, higher requirements have been put forward for the non-oriented silicon steel as the magnetic core material of their core components (i.e. drive motors). The non-oriented silicon steel should have sufficiently high strength to the resist centrifugal force at a high rotational speed, ensuring that the rotor does not deform or fracture at the same time, it should also have excellent electromagnetic properties, especially as low as possible iron loss in the high frequency range of 400 Hz-2000 Hz and high magnetic induction intensity, to meet the requirements of high torque when the motor is started or accelerated.

CN 101490294A with publication date Jul. 22, 2009, entitled “Non-oriented Electromagnetic Steel Sheet with High Strength” discloses a non-oriented electrical steel sheet with a strength of more than 650 MPa. Although the electrical steel sheet has ahigh strength, the iron loss P_{10/400} is as high as 70 W/kg, and the electromagnetic properties are poor.

CN 112930412A with publication date Jun. 8, 2021, entitled “Non-oriented Electrical Steel Sheet and Method for Producing Same, and Motor Core and Method for Producing Same” discloses a non-oriented electrical steel sheet with excellent strength and iron loss. The main solution in CN 112930412A is to anneal the cold-rolled steel sheet with a Si content of 2.8-6.5% at 700-820° C., and strengthen it through the non-completely recrystallized structure with a recrystallization area rate of 40-95%, so that the steel sheet has a yield strength of more than 500 MPa. However, this method cannot simultaneously take into account the low iron loss at high frequency and high magnetic flux intensity requirements of the drive motor.

Based on the above, it is expected to obtain a non-oriented electrical steel with excellent comprehensive performance and a manufacturing method therefor, which has high strength and excellent electromagnetic properties.

### SUMMARY

One of the objectives of the present disclosure is to provide a non-oriented electrical steel with excellent comprehensive performance. The non-oriented electrical steel has small magnetic anisotropy, high magnetic induction intensity, low iron loss at medium and high frequency and high yield strength, and can be widely used in iron core materials of electric vehicle drive motors, high-speed motors, and unmanned aerial vehicles, etc.

In order to achieve the above-mentioned objective, the present disclosure provides a non-oriented electrical steel comprising, in addition to Fe and inevitable impurities, the following chemical elements in percentage by mass:

C≤0.0050%, Si: 3.10-4.50%, Al: 0.10-2.00%, Mn: 0.10-2.50%; and satisfying 3.75%≤Si+Al≤5.22%, preferably 3.75%≤Si+Al≤5.00%.

Preferably, the present disclosure provides a non-oriented electrical steel comprising the following chemical elements in percentage by mass:

C≤0.0050%, Si: 3.10-4.50%, Al: 0.10-2.00%, Mn: 0.10-2.50%, and the balance being Fe and inevitable impurities; and satisfying 3.75%≤Si+Al≤5.22%, preferably 3.75%≤Si+Al≤5.00%.

In the non-oriented electrical steel according to the present disclosure, the design principles of each chemical element are as follows:

C: In the non-oriented electrical steel according to the present disclosure, the C element is an impurity element, which is harmful to the magnetic properties of the non-oriented silicon steel. Therefore, the content of the C element should be controlled to C≤0.0050%, for example, C≤0.0042%, or C≤0.0030%.

Si: In the non-oriented electrical steel according to the present disclosure, Si can increase the resistivity, reduce the iron loss of the non-oriented electrical steel sheet, and can also improve the strength of the steel sheet as a solid solution strengthening element. When the content of Si is higher than 4.50%, an ordered phase FesSi or FeSi will form, the room-temperature plasticity of the material will deteriorate sharply, industrial large-scale cold rolling production cannot be carried out, and the magnetic induction intensity will also deteriorate. When the content of Si is less than 3.10%, the effects of high yield strength and low iron loss at high frequency cannot be achieved. Based on the above, the content of the Si element is controlled at 3.10-4.50%. For example, the upper limit of the Si content may be 4.00%, or 3.78%, etc., and the lower limit of the Si content may be 3.25%, etc.

Al: In the non-oriented electrical steel according to the present disclosure, Al is also an effective element for increasing resistivity and reducing iron loss. However, the excessive addition of Al is detrimental to the magnetic induction intensity of the material, and will cause difficulties in steelmaking and casting, and the cold working performance of the steel sheet will also deteriorate. Therefore, the addition amount of Al is controlled to be no more than 2.00%. At the same time, considering the effect of this element in improving iron loss, the addition amount is controlled to be no less than 0.10%. Based on the above, the content of Al is controlled to be 0.10-2.00%. For example, the upper limit of the Al content may be 1.50%, or 1.35%, etc., and the lower limit of the Al content may be 0.15%, 0.50%, or 0.65%, etc.

In addition, in the present disclosure, the total content of the two alloy elements Si and

Al is particularly controlled to be 3.75%-5.22%, preferably 3.75%-5.00%, this is because: these two elements are both solid solution strengthening elements and increase the resistivity of the material. If the total content is lower than 3.75%, the performance of the non-oriented silicon steel sheet of the present disclosure cannot be achieved. If the total content is higher than 5.22%, it will cause difficulties in cold rolling production and reduce magnetic induction. For example, the upper limit of the content of Si+Al may be 5.00%, or 4.80%, etc., and the lower limit of the content of Si+Al may be 3.95%, or 4.10%, etc.

Mn: In the non-oriented electrical steel according to the present disclosure, Mn can improve the resistivity and react with the impurity element S to form MnS, thereby improving the electromagnetic properties. Therefore, the addition of Mn of 0.10% or more is necessary, while the addition of Mn of more than 2.50% will reduce the plasticity of the steel and cause the strip to break during cold rolling. Therefore, the content of Mn is controlled to be 0.10%-2.50%, preferably 0.10-2.00%. For example, the upper limit of the Mn content may be 1.84%, or 1.51%, etc., and the lower limit of the Mn content may be 0.15%, 0.35%, or 0.65%, etc.

Preferably, the content of the C element is C≤0.0030%.

Preferably, among the inevitable impurities, P≤0.040%, S≤0.0030%, N≤0.0050%, O≤0.0030%, Nb+V+Ti≤0.0050%.

More preferably, among the inevitable impurities, P≤0.020%, N≤0.0035%.

In the non-oriented electrical steel according to the present disclosure, the elements P, S, N, O, Nb, V and Ti are all impurity elements. Where technical conditions permit, in order to obtain a steel with better performance and better quality, the content of impurity elements in the steel should be reduced as much as possible. Wherein:

P: P is a grain boundary segregation element. For the composition system with a Si content of more than 3.10% according to the present disclosure, if the content of P is higher than 0.040%, the electrical steel sheet will have aggravated brittleness and be difficult to roll. For example, the P content may be P≤0.034%, P≤0.024%, or P≤0.020%.

S: In the present disclosure, S is an element harmful to magnetic properties, which will combine with Mn to form fine MnS, thereby hindering the growth of grains during the annealing of the finished product and deteriorating the magnetic properties of the steel sheet. Therefore, the content of the S element in percentage by mass is controlled to: S≤0.0030%. For example, S≤0.0018%, or S≤0.0015%, etc.

N: In the present disclosure, N is an element harmful to magnetic properties, which will combine with Al, Ti, Nb, and V to form fine nitrides, thereby hindering the growth of grains. Therefore, in the non-oriented electrical steel according to the present disclosure, the content of the N element in percentage by mass is controlled to: N≤0.0050%. For example, N≤0.0035%, or N≤0.0015%.

O: In the present disclosure, O is a harmful element. For a composition system with 3.75%≤Si+Al≤5.22%, the cold working performance of the material is very sensitive to the oxygen segregation at grain boundary, and the formed silicon, aluminum, and manganese oxides can also deteriorate the magnetic properties of the material. Therefore, in the present disclosure, the content of the O element in percentage by mass is controlled to: O≤0.0030%, for example, O≤0.0021%, or O≤0.0015%.

Nb, V and Ti can combine with the residual C and N in the steel to form fine carbides and nitrides, which seriously affect the grain growth during annealing and are detrimental to the magnetic properties of the material. Therefore, in the present disclosure, the total content of the three elements of Nb, V, and Ti in percentage by mass is controlled to be 0.0050% or less, for example, 0.0045% or less, 0.0035% or less. Preferably, the non-oriented electrical steel according to the present disclosure further comprises B: 0.0003-0.0100%.

In the above technical solution according to the present disclosure, in order to further optimize the performance of the non-oriented electrical steel according to the present disclosure, preferably an appropriate amount of the B element can be added to the steel.

B: in the non-oriented electrical steel according to the present disclosure, B is a grain boundary strengthening element, which can enhance the grain boundary bonding ability of the high-silicon composition system, thereby improving the cold rolling processing performance of the material. However, when excessive B element is added, it will refine the grain structure, which is not conducive to the magnetic properties. Therefore, the content of B in percentage by mass should be no more than 0.0100%. When the B element in the steel is less than 0.0003%, the grain boundary strengthening effect cannot be achieved. For example, the upper limit of the B content may be 0.0080%, the lower limit of the B content may be 0.0010%.

Preferably, the non-oriented electrical steel according to the present disclosure comprises at least one selected from Sn and Sb, and the total content of Sn and Sb is 0.005-0.300%. For example, the total content of Sn and Sb may be 0.010-0.300%.

Sn and Sb are both grain boundary segregation elements. On the one hand, Sn and Sb can hinder the diffusion of trace oxygen along grain boundaries during the normalizing annealing process of the hot-rolled sheet, preventing oxidation and plasticity degradation in the steel sheet. On the other hand, Sn and Sb can improve the textures beneficial to magnetic properties such as {100} plane texture and Goss texture in the annealing process of the finished sheet.

Preferably, the non-oriented electrical steel according to the present disclosure further comprises at least one selected from Co, Ni, Cu and Cr, and the total content of these elements in percentage by mass is controlled to 0.02-3.00%. For example, the total content of Co, Ni, Cu and Cr may be 0.30-3.00%, such as 0.40-2.00%.

Co, Ni, Cu and Cr elements can have an effect in terms of solid solution strengthening. These elements can further improve the electromagnetic properties and strength of the material without damaging the cold working performance of the steel sheet.

Preferably, the non-oriented electrical steel according to the present disclosure has an average grain size of 10-110 μm, preferably 35-98 μm.

If the grain size of the finished sheet is less than 10 μm, the requirement of the present disclosure for iron loss P_{10/600} performance cannot be met. If the grain size of the finished sheet is greater than 110 μm, the yield strength will decrease, the production efficiency will be low, the requirement for production equipment will be high, and the cost will increase.

Preferably, the non-oriented electrical steel according to the present disclosure has a thickness of 0.10 to 0.30 mm, for example, 0.15 to 0.30 mm.

The non-oriented electrical steel according to the present disclosure has excellent comprehensive performance, including high strength, low iron loss, high magnetic induction and low magnetic anisotropy.

Preferably, the non-oriented electrical steel according to the present disclosure has a yield strength of ≥430 MPa, preferably ≥455 MPa.

Preferably, the non-oriented electrical steel according to the present disclosure has an iron loss P_{10/600} of ≤35.0 W/kg (preferably P_{10/600}≤29.3 W/kg) at a magnetic flux density of 1.0 T and a frequency of 600 Hz, a magnetic induction intensity B₅₀ of ≥1.640 T (preferably B₅₀≥1.654 T), and a difference ΔB between the longitudinal magnetic induction intensity B_{50L} and the transverse magnetic induction intensity B_{50C} is not more than 1000 Gauss (preferably ΔB is not more than 822 Gauss).

Correspondingly, another objective of the present disclosure is to provide a method for manufacturing the above-mentioned non-oriented electrical steel. The manufacturing method is simple and feasible, by which a non-oriented electrical steel sheet with excellent comprehensive performance can be obtained.

In order to achieve the above-mentioned objective, the present disclosure provides a method for manufacturing the non-oriented electrical steel, comprising the following steps:
(1) preparing a casting slab;
(2) hot rolling: controlling the reduction rate of the last pass in rough rolling to 35-55%, heat holding an intermediate slab obtained from rough rolling for 50-80s before entering a finishing mill, the temperature of the intermediate slab is 960-1100° C. (preferably 965-1100° C.) and the temperature difference (ΔT) between the head and tail of the intermediate slab is ≤40° C. (preferably ≤35° C.) when entering the finishing mill;
(3) normalizing annealing;
(4) cold rolling;
(5) final annealing;
(6) applying an insulating coating.

Preferably, in step (2), the ratio I of the {001} plane texture strength to the {111} <112> texture strength is ≥0.55 at a position within the intermediate slab where the distance from the slab surface is one quarter of the slab thickness before entering the finishing mill.

In the present disclosure, the inventor optimizes the chemical composition design of the steel, and determines a reasonable manufacturing process, wherein after preparing a continuous casting slab according to the designed chemical composition, the continuous casting slab is sequentially subjected to hot rolling, normalizing annealing, cold rolling (which may be a single cold rolling or a double cold rolling with intermediate annealing), final annealing, and applying an insulating coating to obtain a non-oriented electrical steel with excellent comprehensive performance.

Preferably, during the hot rough rolling of the continuous casting slab, the reduction rate of the last pass is controlled to be 35-55% to obtain the intermediate slab. Before entering the hot rolling finishing mill, the intermediate slab needs to stay on a roller table with a heat preservation cover for 50-80s, or it can also be re-coiled and uncoiled using the hot coil box equipment after the roughing mill to achieve a thermal holding time of 50-80s. The temperature of the intermediate slab is controlled at 960-1100° C. and the temperature difference ΔT between the head and tail of the intermediate slab is ≤40° C. when entering the first stand of the finishing mill.

The above-mentioned process parameters are limited mainly to make the intermediate slab fully recrystallize, reduce the solid solution precipitation of second phases such as AlN, MnS, and TiC, increase the textures beneficial to magnetic properties, and especially control the {001} plane texture strength at a position where the distance from the intermediate slab surface is one quarter of the slab thickness, so that the ratio I of such {001} plane texture strength to the {111}<112> texture strength is ≥0.55, thereby achieving the technical effect of improving the texture of the finished annealed sheet, reducing the magnetic anisotropy, the difference ΔB between the longitudinal magnetic induction intensity B_{50L} and the transverse magnetic induction intensity B_{50C} of ≤1000 Gauss, and the magnetic induction intensity B₅₀ of more than 1.64 T.

In addition, the temperature difference ΔT between the head and tail of the intermediate slab is controlled to be ≤40° C. On the one hand, it can ensure the consistency of the performance of the entire coil of the steel strip product, and on the other hand, it can achieve constant-speed and constant-temperature rolling of the subsequent finishing mill, greatly reducing the risk of motor overcurrent when the finishing mill produces thin-gauge, high-grade non-oriented silicon steel, thereby ensuring the stability of continuous production.

Preferably, in step (2), the thickness of the intermediate slab obtained by rough rolling is 25-40 mm.

Preferably, in step (3), the normalizing temperature is 850-1050° C., the normalizing holding time is, for example, 90s.

Preferably, in step (5), the final annealing temperature is 750-1000° C., the final annealing time is 11 s-125 s.

The final annealing process is intended to better achieve the target grain size of the finished non-oriented electrical steel sheet of 10-110 μm. If the annealing temperature is too low or the annealing time is too short, the grain size of the finished sheet will be less than 10 μm, the requirement of the present disclosure for iron loss P_{10/600} performance cannot be satisfied. If the annealing temperature is too high or the annealing time is too long, the grain size of the finished steel sheet will exceed 110 μm, the yield strength will decrease, the production efficiency will be low, and the cost will be increased.

The non-oriented electrical steel and the manufacturing method therefor described in the present disclosure have the following advantages and beneficial effects:

The non-oriented electrical steel according to the present disclosure has small magnetic anisotropy, high magnetic induction intensity, low iron loss at medium and high frequency, high yield strength, and can be widely used in iron core materials of electric vehicle drive motors, high-speed motors, and unmanned aerial vehicles, etc.

Preferably, the non-oriented electrical steel according to the present disclosure has a yield strength of ≥430 MPa (preferably ≥455 MPa), an iron loss P_{10/600}≤35.0 W/kg (preferably P_{10/600}≤29.3 W/kg), a magnetic induction intensity B₅₀≥1.640 T (preferably B₅₀≥1.654 T), and a difference ΔB between the longitudinal magnetic induction intensity B_{50L} and the transverse magnetic induction intensity B_{50C} of ≤1000 Gauss (preferably ΔB is ≤822 Gauss).

Unless otherwise explicitly stated or there is an obvious contradiction, the endpoint values of the ranges described herein may be combined in any manner to generate additional ranges or subranges. For example, in some embodiments, the upper limit value described for a certain feature may also be used as the lower limit value of the feature; the lower limit value described for a certain feature may also be used as the upper limit value of the feature.

### DETAILED DESCRIPTION

The non-oriented electrical steel and the manufacturing method therefor according to the present disclosure will be further explained and illustrated below with reference to the specific embodiments. However, the explanations and illustrations do not constitute undue limitations on the technical solutions of the present disclosure.

### Examples 1-10 and Comparative Examples 1-5

Table 1 lists the mass percentage of each chemical element in the finished electrical steels of examples 1-10 and comparative examples 1-5.

TABLE 1
(wt %, the balance is Fe and inevitable impurities other than P, S, O, N, Nb, V, Ti)

| | | | | | | | | | | | | Nb + | Si + |
|---|---|---|---|---|---|---|---|---|---|---|---|---|---|
| Number | C | Si | Al | Mn | P | S | N | O | B | Sn, Sb | Co, Ni, Cu, Cr | V + Ti | Al |
| Example 1 | 0.0042 | 3.10 | 0.85 | 1.95 | 0.005 | 0.0018 | 0.0012 | 0.0015 | — | — | — | 0.0035 | 3.95 |
| Example 2 | 0.0021 | 3.25 | 0.50 | 1.84 | 0.007 | 0.0015 | 0.0004 | 0.0008 | — | Sn + Sb: 0.050 | — | 0.0041 | 3.75 |
| Example 3 | 0.0014 | 3.22 | 2.00 | 0.85 | 0.019 | 0.0015 | 0.0005 | 0.0021 | 0.0100 | Sn: 0.300 | — | 0.0028 | 5.22 |
| Example 4 | 0.0019 | 3.25 | 1.51 | 0.55 | 0.018 | 0.0005 | 0.0015 | 0.0019 | 0.0003 | — | Ni + Cr: 0.80 | 0.0031 | 4.76 |
| Example 5 | 0.0015 | 3.45 | 1.35 | 1.51 | 0.034 | 0.0016 | 0.0014 | 0.0009 | 0.0010 | Sn: 0.130 | Ni + Cr: 0.40 | 0.0038 | 4.80 |
| Example 6 | 0.0015 | 3.49 | 1.50 | 0.65 | 0.014 | 0.0016 | 0.0015 | 0.0008 | 0.0050 | — | Cu + Cr + Co: | 0.0045 | 4.99 |
| | | | | | | | | | | | 2.00 | | |
| Example 7 | 0.0015 | 3.78 | 0.65 | 0.35 | 0.024 | 0.0004 | 0.0015 | 0.0014 | 0.0080 | — | Ni: 0.50 | 0.0042 | 4.43 |
| Example 8 | 0.0018 | 4.00 | 0.10 | 0.15 | 0.009 | 0.0003 | 0.0008 | 0.0005 | 0.0080 | — | Ni + Co: 0.30 | 0.0035 | 4.10 |
| Example 9 | 0.0017 | 4.50 | 0.15 | 0.10 | 0.007 | 0.0005 | 0.0009 | 0.0005 | 0.0080 | Sb: 0.010 | Cu + Ni + Cr: | 0.0027 | 4.65 |
| | | | | | | | | | | | 3.00 | | |
| Example 10 | 0.0014 | 3.15 | 0.75 | 2.5 | 0.004 | 0.0002 | 0.0021 | 0.0010 | — | — | Co + Ni + Cu + Cr: | 0.0031 | 3.90 |
| | | | | | | | | | | | 0.02 | | |
| Comparative | 0.0020 | 2.60 | 1.50 | 0.50 | 0.022 | 0.0027 | 0.0021 | 0.0015 | — | — | — | 0.0048 | 4.10 |
| example 1 | | | | | | | | | | | | | |
| Comparative | 0.0021 | 2.10 | 0.50 | 0.50 | 0.019 | 0.0018 | 0.0022 | 0.0032 | — | — | — | 0.0041 | 2.60 |
| example 2 | | | | | | | | | | | | | |
| Comparative | 0.0037 | 3.00 | 0.20 | 0.50 | 0.021 | 0.0013 | 0.0020 | 0.0023 | 0.0010 | — | — | 0.0075 | 3.20 |
| example 3 | | | | | | | | | | | | | |
| Comparative | 0.0015 | 3.20 | 0.80 | 0.20 | 0.024 | 0.0020 | 0.0026 | 0.0020 | — | — | — | 0.0045 | 4.00 |
| example 4 | | | | | | | | | | | | | |
| Comparative | 0.0018 | 3.30 | 0.75 | 0.20 | 0.026 | 0.0028 | 0.0020 | 0.0021 | — | — | — | 0.0045 | 4.05 |
| example 5 | | | | | | | | | | | | | |

The non-oriented electrical steels of examples 1-10 was prepared by the following steps:
(1) smelting and casting molten steel to obtain a casting slab.
(2) hot rolling (including rough rolling and finishing rolling): the reduction rate of the last pass in rough rolling was controlled to be 35-55% to obtain an intermediate slab with a thickness of 25-40 mm; the intermediate slab stayed and was subject to heat holding for 50-80s before entering the finishing mill; the ratio I of the {001} plane texture strength to the {111}<112> texture strength was ≥0.55 at a position within the intermediate slab where the distance from the slab surface is one quarter of the slab thickness before entering the finishing mill; the temperature of the intermediate slab was 960-1100° C. and the temperature difference ΔT between the head and tail of the intermediate slab was controlled to be ≤40° C. when entering the finishing mill.
(3) normalizing annealing: the normalizing temperature of examples 1-4 was 1050° C., the normalizing temperature of examples 5-7 was 920° C., and the normalizing temperature of examples 8-10 was 850° C.; the normalizing temperature of comparative examples 1-5 was 920° C.; the normalizing holding time of examples 1-10 and comparative examples 1-5 was 90 s.
(4) cold rolling: rolling to the target thickness through a single cold rolling, or rolling to a sheet with a thickness of 0.10 to 0.30 mm through primary cold rolling+intermediate annealing+secondary cold rolling.
(5) final annealing: the final annealing temperature was 750-1000° C., and the final holding time was 11 s-125 s.
(6) apply an insulation coating.

It should be noted that, although comparative examples 1-5 were also prepared using the above-mentioned process steps, one or more of their specific process parameters and/or chemical element contents do not meet the control requirements of the present disclosure.

Table 2 lists the specific manufacturing process parameters and final finished product thickness of the electrical steels of examples 1-10 and comparative examples 1-5.

TABLE 2

| | Finished | Reduction | | | Temperature of | Temperature | | | |
|---|---|---|---|---|---|---|---|---|---|
| | product | rate of the | | | the intermediate | difference | | | |
| | Thickness of | last pass | Heat | | slab when | between the head | | Final | |
| | the finished | in rough | holding | | entering the | and tail of the | | annealing | Final |
| | product | rolling | time | | finishing | intermediate | Cold rolling | temperature | annealing |
| Number | (mm) | (%) | (s) | I | mill (° C.) | slab (° C.) | process | (° C.) | time (s) |
| Example 1 | 0.27 | 40 | 55 | 0.55 | 990 | 35 | Single cold rolling | 890 | 20 |
| Example 2 | 0.30 | 35 | 50 | 0.78 | 1100 | 20 | Single cold rolling | 910 | 20 |
| Example 3 | 0.30 | 55 | 65 | 0.89 | 1032 | 30 | Single cold rolling | 850 | 35 |
| Example 4 | 0.15 | 40 | 65 | 1.1 | 980 | 28 | Double cold rolling | 900 | 70 |
| Example 5 | 0.25 | 50 | 55 | 0.95 | 990 | 32 | Double cold rolling | 980 | 25 |
| Example 6 | 0.25 | 38 | 70 | 0.65 | 1035 | 15 | Double cold rolling | 750 | 15 |
| Example 7 | 0.25 | 40 | 68 | 1.35 | 965 | 20 | Double cold rolling | 900 | 125 |
| Example 8 | 0.30 | 38 | 54 | 0.56 | 996 | 18 | Double cold rolling | 1000 | 11 |
| Example 9 | 0.30 | 39 | 80 | 0.58 | 1085 | 10 | Double cold rolling | 950 | 15 |
| Example 10 | 0.30 | 40 | 60 | 0.72 | 1050 | 25 | Single cold rolling | 980 | 35 |
| Comparative | 0.25 | 40 | 55 | 0.95 | 1000 | 40 | Single cold rolling | 1050 | 20 |
| example 1 | | | | | | | | | |
| Comparative | 0.30 | 37 | 55 | 0.65 | 1000 | 40 | Single cold rolling | 960 | 60 |
| example 2 | | | | | | | | | |
| Comparative | 0.30 | 37 | 60 | 1.35 | 990 | 40 | Double cold rolling | 920 | 60 |
| example 3 | | | | | | | | | |
| Comparative | 0.25 | 60 | 45 | 0.33 | 950 | 80 | Single cold rolling | 840 | 20 |
| example 4 | | | | | | | | | |
| Comparative | 0.25 | 25 | 130 | 0.42 | 940 | 115 | Single cold rolling | 960 | 30 |
| example 5 | | | | | | | | | |

Note:
the ratio I of the {001} plane texture strength to the {111}<112> texture strength at a position within the intermediate slab where the distance from the surface is one quarter of the thickness in table 2 is obtained by XRD diffractometer test.

The finished electrical steels of examples 1-10 and comparative examples 1-5 finally obtained were sampled and tested for iron loss P_{10/600} at a magnetic flux density of 1.0 T and a frequency of 600 Hz, magnetic induction intensity B₅₀, longitudinal magnetic induction intensity B_{50L} and transverse magnetic induction intensity B_{50C} when magnetized under a magnetic field of 5000 A/m, and yield strength. The test results are listed in Table 3 below. The test methods of the relevant performances are described as follows:

The grain size of the finished sheet is measured based on the area method of the standard “GB/T6394-2017 Method for Determination of Average Grain Size of Metal”.

The iron loss P_{10/600} test is based on the square method of the standard “GB/T10129-2019 Method for Measuring Medium Frequency Magnetic Properties of Electrical Steel Strip (Piece)”.

The magnetic induction intensity is measured based on the square method of the standard “GB/T3655-2008 Method for Measuring Magnetic Properties of Electrical Steel Piece (Strip) Using Epstein Square”, and the B₅₀, longitudinal B_{50L}, and transverse B_{50C} are tested respectively.

The yield strength performance index is measured based on the standard “GB/T228.1-2010 Metallic Material Tensile Test Part 1: Room Temperature Test Method”.

Table 3 lists the test results of the finished electrical steels of examples 1-10 and comparative examples 1-5.

TABLE 3

| | Average grain | P_{10/600} | B₅₀ | ΔB | Yield |
|---|---|---|---|---|---|
| Number | size (μm) | (W/kg) | (T) | (Gs) | strength (MPa) |
| Example 1 | 55 | 34.1 | 1.660 | 520 | 435 |
| Example 2 | 62 | 31.3 | 1.665 | 452 | 441 |
| Example 3 | 35 | 29.3 | 1.654 | 625 | 455 |
| Example 4 | 85 | 28.6 | 1.701 | 750 | 445 |
| Example 5 | 98 | 24.1 | 1.676 | 620 | 485 |
| Example 6 | 10 | 31.5 | 1.665 | 350 | 495 |
| Example 7 | 108 | 22.4 | 1.652 | 473 | 504 |
| Example 8 | 88 | 23.1 | 1.648 | 565 | 512 |
| Example 9 | 75 | 21.3 | 1.642 | 822 | 521 |
| Example 10 | 95 | 32.6 | 1.648 | 745 | 440 |
| Comparative | 140 | 32.2 | 1.685 | 410 | 372 |
| example 1 | | | | | |
| Comparative | 100 | 51.5 | 1.701 | 550 | 305 |
| example 2 | | | | | |
| Comparative | 95 | 42.1 | 1.675 | 755 | 365 |
| example 3 | | | | | |
| Comparative | 30 | 31.5 | 1.631 | 1150 | 465 |
| example 4 | | | | | |
| Comparative | 95 | 25.2 | 1.628 | 1100 | 485 |
| example 5 | | | | | |

According to Table 1, Table 2 and Table 3, it can be seen that in comparative examples 1 and 2, the Si content is not within the scope of the present disclosure, resulting in that the grain size of the finished product of comparative example 1 exceeds the upper limit, the yield strength is low, and the iron loss of comparative example 2 is high.

The Si content in comparative example 3 does not meet the requirement of the present disclosure, and the content of Si+Al is less than 3.75%, resulting in a low yield strength. Although the compositions of comparative examples 4 and 5 meet the requirements of the present disclosure, the hot rolling process parameters and texture ratio I are not within the specified range, so comparative examples 4 and 5 fail to obtain the desired magnetic induction intensity and magnetic anisotropy of the finished product of the present disclosure.

Examples 1-2 of the present disclosure adopt a single cold rolling process, and the chemical composition, the reduction rate of the last rough rolling, the heat holding time, the temperature of the intermediate slab when entering the finishing mill, the temperature difference between the head and tail of the intermediate slab, and the grain size of the finished product are all within the designed range of the present disclosure, so that the non-oriented silicon steels with excellent comprehensive performance of high yield strength and excellent magnetic properties can be obtained.

In example 2 of the present disclosure, Sn and Sb are further added, and the strength and iron loss are better than those of example 1.

In example 3 of the present disclosure, B are further added, and the strength and iron loss are better than those of example 1.

In examples 4-9 of the present disclosure, the performance of the finished steel sheets is further improved by further adding at least one selected from the microalloying elements Sn, Sb, Co, Ni, Cu, and Cr and a double cold rolling process.

In example 10 of the present disclosure, the microalloying elements such as Co, Ni, Cu and Cr are further added, and the strength and iron loss are better than those of example 1.

It should be noted that the prior art portion in the protective scope of the present disclosure is not limited to the embodiments provided in the application document, and all prior arts that do not contradict the solution of the present disclosure, including but not limited to prior patent documents, prior public publications, prior public use, etc., can all be included in the protection scope of the present disclosure.

Moreover, the combinations of the technical features of the present disclosure are not limited to combinations described in the claims or the specific embodiments of the present disclosure, and all the technical features described in the present disclosure can be freely combined in any manners unless contradicted with each other.

It should be further noted that the embodiments demonstrated above are merely specific examples of the present disclosure. It is obvious that the present disclosure is not limited to the above-mentioned embodiments, and various changes or modifications can be made. Such changes or modifications can be directly obtainable or easily conceivable for those skilled in the art from the disclosure in the present disclosure, and all of which fall within the protection scope of the present disclosure.

1. A non-oriented electrical steel comprising, in addition to Fe and inevitable impurities, the following chemical elements in percentage by mass:
C≤0.0050%, Si: 3.10-4.50%, Al: 0.10-2.00%, Mn: 0.10-2.50%; and satisfying 3.75%≤Si+Al≤5.22%, preferably 3.75%≤Si+Al≤5.00%.

2. The non-oriented electrical steel according to claim 1, wherein the non-oriented electrical steel comprises the following chemical elements in percentage by mass:
C≤0.0050%, Si: 3.10-4.50%, Al: 0.10-2.00%, Mn: 0.10-2.50%, and the balance being Fe and inevitable impurities; and satisfies 3.75%≤Si+Al≤5.22%, preferably 3.75%≤Si+Al≤5.00%.

3. The non-oriented electrical steel according to claim 1, wherein C≤0.0030%.

4. The non-oriented electrical steel according to claim 1, wherein
among the inevitable impurities, P≤0.040%, S≤0.0030%, N≤0.0050%, O≤0.0030%, and Nb+V+Ti≤0.0050%.

5. The non-oriented electrical steel according to claim 4, wherein P≤0.020%, N≤0.0035%.

6. The non-oriented electrical steel according to claim 1, wherein the non-oriented electrical steel further comprises B: 0.0003-0.0100%.

7. The non-oriented electrical steel according to claim 1, wherein the steel further comprises at least one selected from Sn and Sb, and a total content of Sn and Sb in percentage by mass is 0.005-0.300%.

8. The non-oriented electrical steel according to claim 1, wherein the non-oriented electrical steel further comprises at least one selected from Co, Ni, Cu and Cr, and a total content of Co, Ni, Cu and Cr in percentage by mass is 0.02-3.00%, preferably 0.30-3.00%.

9. The non-oriented electrical steel according to claim 1, wherein the non-oriented electrical steel has an average grain size of 10-110 μm.

10. The non-oriented electrical steel according to claim 1, wherein the non-oriented electrical steel has a thickness of 0.10 to 0.30 mm.

11. The non-oriented electrical steel according to claim 1, wherein the non-oriented electrical steel has a yield strength of ≥430 MPa, an iron loss P_{10/600} of ≤35.0 W/kg, a magnetic induction intensity B₅₀ of ≥1.640 T, and a difference ΔB between a longitudinal magnetic induction intensity B_{50L} and a transverse magnetic induction intensity B_{50C} of no more than 1000 Gauss.

12. A method for manufacturing the non-oriented electrical steel according to claim 1, comprising the following steps:
(1) preparing a casting slab;
(2) hot rolling: a reduction rate of last pass in rough rolling is 35-55%, heat holding an intermediate slab obtained by rough rolling for 50-80 s before entering a finishing mill, a temperature of the intermediate slab is 960-1100° C. and a temperature difference (ΔT) between the head and tail of the intermediate slab is ≤40° C. when entering the finishing mill;
(3) normalizing annealing;
(4) cold rolling;
(5) final annealing;
(6) applying an insulating coating.

13. The method according to claim 12, wherein in step (2), a ratio I of a {001} plane texture strength to a {111}<112> texture strength is ≥0.55 at a position within the intermediate slab where a distance from the slab surface is one quarter of the slab thickness before entering the finishing mill.

14. The method according to claim 12, wherein in step (2), the intermediate slab obtained by rough rolling has a thickness of 25-40 mm.

15. The method according to claim 12, wherein in step (3), the normalizing is performed at a temperature of 850-1050° C.

16. The method according to claim 12, wherein in step (5), the final annealing is performed at a temperature of 750-1000° C. for 11-125 s.

17. The non-oriented electrical steel according to claim 2, wherein C≤0.0030%.

18. The non-oriented electrical steel according to claim 2, wherein among the inevitable impurities, P≤0.040%, S≤0.0030%, N≤0.0050%, O≤0.0030%, and Nb+V+Ti≤0.0050%.

19. The non-oriented electrical steel according to claim 2, wherein the non-oriented electrical steel further comprises B: 0.0003-0.0100%.

20. The non-oriented electrical steel according to claim 2, wherein the steel further comprises at least one selected from Sn and Sb, and a total content of Sn and Sb in percentage by mass is 0.005-0.300%.
